(19) United States
(12) Patent Application Publication
(10) Pub. No.: US 2026/0149921 A1
(43) Pub. Date: May 28, 2026

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: KEIICHI TANESAWA, Kanagawa (JP)

(21) Appl. No.: 19/391,771

(22) Filed: Nov. 17, 2025

(30) Foreign Application Priority Data
Nov. 27, 2024 (JP) 2024-206480

(51) Int. Cl. H04R 3/00; H04R 1/40

(52) U.S. Cl. CPC H04R 3/005; H04R 1/406; H04R 2410/01

(57) ABSTRACT

An information processing apparatus includes: one or more memories storing instructions; and one or more processors executing the instructions to: detect a position of an object in a predetermined area; select a processing target microphone group that satisfies a predetermined condition for a positional relationship with the object, the processing target microphone group being included in a plurality of microphone groups for collecting sound in the predetermined area; in response to a change of the selected processing target microphone group, execute a noise reduction process on sound data; generate, by the processing target microphone group including processing target microphone groups, highly directional sound data for each processing target microphone group from collected sound signals acquired from a plurality of microphones; and based on a plurality of pieces of sound data including the generated highly directional sound data, generate sound for reproduction.

### BACKGROUND

### Field of the Technology

The present disclosure relates to an information processing apparatus, a method for controlling an information processing apparatus, and a program.

### Description of the Related Art

To enhance the sense of presence in viewing a virtual viewpoint image representing a view of a predetermined area from an optionally designated viewpoint requires that sound matching the virtual viewpoint be generated. For example, in a case where game sound such as ball kick sound is reproduced together with a virtual viewpoint image from such a viewpoint that approaches a player or a ball in a field of soccer, rugby football, or the like, it is desirable that the game sound be loud. However, due to difficulty in installing microphones in the field, the microphones that collect the sound are only installed outside the field and are oriented toward the field.

If there is a long distance between where a sound occurs in the field of play and a microphone position outside the field, cheers may drown out the game sound resulting in the game sound not being collected.

Japanese Patent Laid-Open No. 2021-82971 discloses technology for appropriately selecting a microphone group in accordance with the position of an object, the microphone group being provided for acquiring a plurality of collected sound signals to be used for a process for generating highly directional sound data by using the plurality of collected sound signals of sound collected with a plurality of microphones.

However, in the technology disclosed in Japanese Patent Laid-Open No. 2021-82971, the selected processing target microphone group varies with the change of a sound collection target position. The variation in the processing target microphone group causes virtual viewpoint sound to be generated by combining pieces of highly directional sound data based on different processing target microphone groups, thus resulting in a discontinuous waveform in a connection portion on occasions. As the result, the virtual viewpoint sound generated based on highly directional sound data including the discontinuous portion also includes discontinuous sound which causes a viewer to recognize the portion as noise.

### SUMMARY

The present disclosure provides technology for reducing noise when generating sound for a virtual viewpoint image.

An information processing apparatus includes: one or more memories storing instructions; and one or more processors executing the instructions to: detect a position of an object in a predetermined area; select a processing target microphone group that satisfies a predetermined condition for a positional relationship with the object, the processing target microphone group being included in a plurality of microphone groups for collecting sound in the predetermined area; in response to a change of the selected processing target microphone group, execute a noise reduction process on sound data; generate, by the processing target microphone group including processing target microphone groups, highly directional sound data for each processing target microphone group from collected sound signals acquired from a plurality of microphones; and based on a plurality of pieces of sound data including the generated highly directional sound data, generate sound for reproduction.

Features of the present disclosure will become apparent from the following description of embodiments with reference to the attached drawings. The following description of embodiments is described by way of example.

### BRIEF DESCRIPTION OF THE DRAWINGS

FIG. 1 is a view illustrating an example functional configuration of an information processing apparatus.

FIGS. 2A, 2B, and 2C are tables for explaining example table data structures.

FIG. 3A is a flowchart illustrating example processing by the information processing apparatus.

FIG. 3B is a flowchart illustrating an example of a process for updating microphone group selection flags.

FIG. 4 is a view for explaining an example of arrangement and selection of microphone groups.

FIG. 5 is a table for explaining an example table data structure.

FIG. 6A is a flowchart illustrating example processing by an information processing apparatus.

FIG. 6B is a flowchart illustrating an example of a process for updating microphone group selection flags.

FIG. 7 is a view for explaining an example of arrangement and selection of microphone groups.

FIG. 8 is a view illustrating an example hardware configuration of the information processing apparatus.

### DESCRIPTION OF THE EMBODIMENTS

Hereinafter, embodiments of the present disclosure will be described based on the drawings. The following embodiments are not intended to limit the scope of the claims of the disclosure. A plurality of features are described in the embodiments, but limitation is not made to an embodiment that requires all such features of the disclosure, and the plurality of such features may be combined optionally. Furthermore, in the attached drawings, the same or similar components are denoted by the same reference numerals, and repeated description thereof is omitted.

In the following description, a process for generating highly directional sound data by using a plurality of collected sound signals based on sound collection performed with a plurality of microphones is also referred to as a highly directional sound generation process. A set of microphones for acquiring the plurality of collected sound signals to be used for the highly directional sound generation process is also referred to as a microphone group. For example, virtual viewpoint sound for a virtual viewpoint image is generated by using the highly directional sound data generated based on the collected sound signals of the processing target microphone group.

### Embodiment 1

An information processing apparatus executes a noise reduction process in response to the change of a microphone group selected as a microphone group to undergo a highly directional sound generation process. In the following description, for example, the noise reduction process is executed in response to a change between a microphone group selected for a processing frame and a microphone group selected for the frame one frame preceding the processing frame. Noise attributed to a discontinuous waveform occurring due to the use of highly directional sound data based on different microphone groups is thereby reduced. In selecting a microphone group, a microphone group satisfying a predetermined condition for a positional relationship with an object within a predetermined image-pickup area (an object within a predetermined area) is selected as the processing target microphone group. The predetermined condition used is a condition where a distance between the object and the microphone group is less than a threshold distance. In this embodiment, an object denotes, for example, an object or a person attracting attention in the image-pickup (image capture) area such as a ball or a player holding the ball.

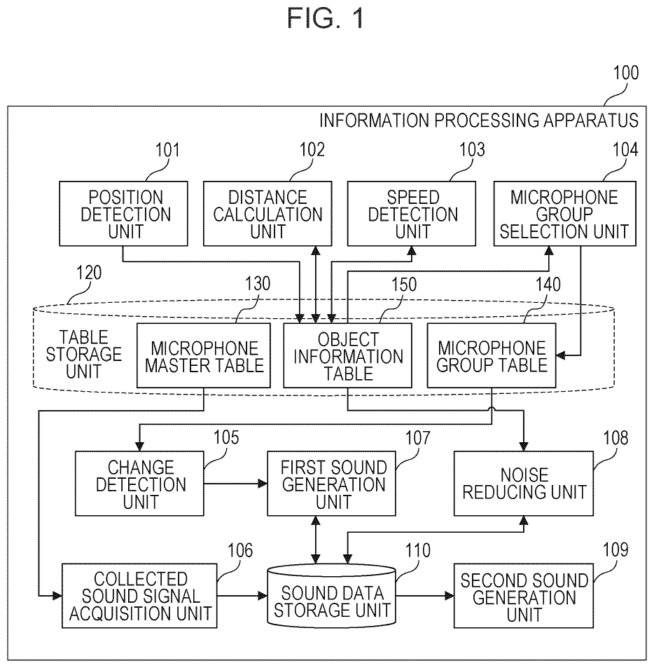

FIG. 1 is a block diagram illustrating an example functional configuration of an exemplary information processing apparatus 100. The information processing apparatus 100 has a position detection unit 101, a distance calculation unit 102, a speed detection unit 103, a microphone group selection unit 104, a change detection unit 105, a collected sound signal acquisition unit 106, a first sound generation unit 107, a noise reducing unit 108, and a second sound generation unit 109. The information processing apparatus 100 also has a sound data storage unit 110 and a table storage unit 120.

The position detection unit 101 reads image data or moving image data to be used to generate a virtual viewpoint image and, based on the data, detects an object within a predetermined area (hereinafter, also referred to as an object) and the position of the object. The virtual viewpoint image in this embodiment is an image that is generated based on a plurality of images in an image-pickup area that are taken in respective different directions and that corresponds to the position and the direction of the designated virtual viewpoint. To detect the object from the image, any publicly known detection method may be applied. In this embodiment, the position of the object is detected based on the image data or the moving image data; however, the detection method is not limited to this. For example, the position of a specific object that is measured by using a position measurement device such as GPSs may be detected as the position of the object.

The distance calculation unit 102 calculates a distance between the position of the object detected by the position detection unit 101 and each of the microphone groups. The speed detection unit 103 detects the speed of the object, based on a chronological change in the position of the object detected by the position detection unit 101. Based on the distance calculated by the distance calculation unit 102, the microphone group selection unit 104 selects a processing target microphone group to undergo the highly directional sound generation process. For each of processing frames, the change detection unit 105 detects whether there is a change of a processing target microphone group selected by the microphone group selection unit 104.

The collected sound signal acquisition unit 106 acquires collected sound signals collected by using all of the microphones registered in a microphone master table 130 and stores the collected sound signals as sound data in the sound data storage unit 110. The first sound generation unit 107 executes the highly directional sound generation process on the microphone group selected by the microphone group selection unit 104. In the highly directional sound generation process, the plurality of collected sound signals collected with the plurality of microphones belonging to the same microphone group are received, and thereby highly directional sound data is generated by performing signal processing from the plurality of collected sound signals. Such a publicly known signal processing technique that ensures a sensitivity in an intended direction and at the same time lowers sensitivities in directions other than the intended direction, for example, beam forming may be applied to the highly directional sound generation process.

The noise reducing unit 108 executes the noise reduction process on the sound data in response to a change of the processing target microphone group detected by the change detection unit 105. Examples of the noise reduction process executed by the noise reducing unit 108 include a fade-in process and a fade-out process. In the noise reduction process by the noise reducing unit 108, noise attributed to the discontinuous sound waveform is reduced. The second sound generation unit 109 generates the virtual viewpoint sound by using the collected sound signals acquired by the collected sound signal acquisition unit 106 and the highly directional sound data generated by the first sound generation unit 107. In this embodiment, the virtual viewpoint sound serves as sound for reproduction.

The sound data storage unit 110 stores the sound data generated by the collected sound signal acquisition unit 106, the first sound generation unit 107, and the noise reducing unit 108. The table storage unit 120 stores various pieces of information to be used in processing by the information processing apparatus 100. The table storage unit 120 stores, for example, the microphone master table 130, a microphone group table 140, and an object information table 150.

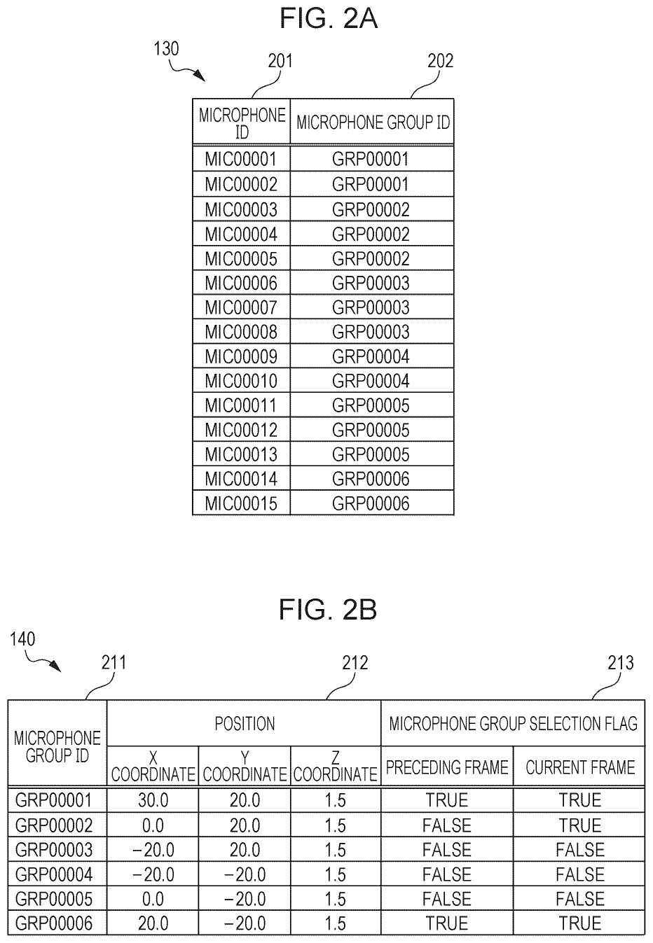

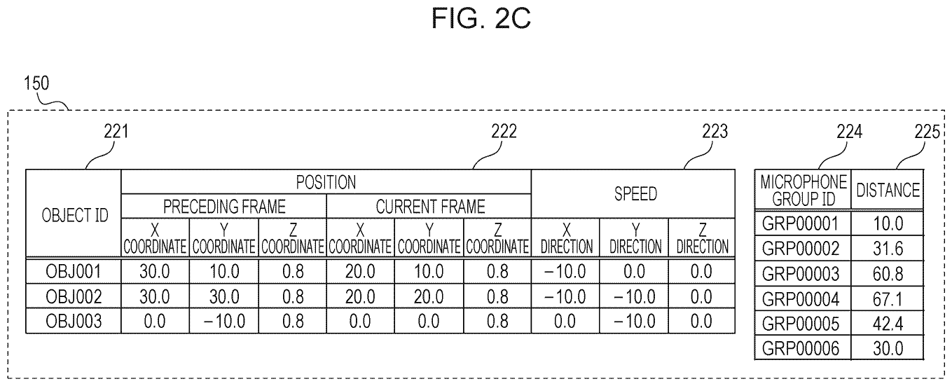

The microphone master table 130 stores information regarding microphones used to collect sound. The installed microphones are managed by using the microphone master table 130. FIG. 2A illustrates an example of the microphone master table 130. As illustrated in FIG. 2A, the microphone master table 130 stores microphone IDs 201 for uniquely identifying the installed microphones and microphone group IDs 202 for identifying microphone groups of the microphones. The highly directional sound generation process is implemented by performing signal processing by using the plurality of collected sound signals collected with the plurality of microphones belonging to the same microphone group.

The microphone group table 140 stores information regarding the microphone groups of the microphones. The microphone groups are managed by using the microphone group table 140. FIG. 2B illustrates an example of the microphone group table 140. As illustrated in FIG. 2B, the microphone group table 140 stores microphone group IDs 211 for uniquely identifying the microphone groups, microphone positions 212 of microphones belonging to the microphone groups, and microphone group selection flags 213. Each microphone position 212 is represented by an X coordinate, a Y coordinate, and a Z coordinate of the position of the corresponding microphone belonging to the microphone group. In this embodiment, regardless of the number of microphones included in the microphone group, the position of the center of gravity of the microphones included in the microphone group serves as the microphone position. The microphone group selection flags 213 are flags for distinguishing whether a microphone group is selected as a processing target to undergo the highly directional sound generation process. In this embodiment, flags for the current processing frame and the frame one frame preceding the current frame are stored under the following conditions. Specifically, if the microphone group is selected as the processing target microphone group to undergo the highly directional sound generation process, TRUE is set. If the microphone group is not selected, FALSE is set.

The object information table 150 stores information regarding the detected object. The information (object information) regarding the object located within the predetermined area and detected as the object is managed by using the object information table 150. FIG. 2C illustrates an example of the object information table 150. The object information table 150 includes a table storing object IDs 221 for uniquely identifying the objects, object positions 222, and object speeds 223 and a table storing microphone group IDs 224 and distances 225. The table storing the microphone group IDs 224 and the distances 225 is provided on a per-object basis, and thus there are tables the number of which is equal to the number of objects. The number of objects and the object IDs may be set in advance. Alternatively, if the position detection unit 101 detects a new object, an object ID may be assigned, and a new row may be added to the table. Each object position 222 is represented by an X coordinate, a Y coordinate, and a Z coordinate of the object position, and the object positions included in the current processing frame and the frame one frame preceding the current frame and detected by the position detection unit 101 are stored. In this embodiment, information regarding the center of gravity of the object is used as the object position. Object positions in the current processing frame and the frame one frame preceding the current frame are stored in this embodiment but are not limited to these. For example, an object position in a frame succeeding the current processing frame may be acquired in advance and stored. Each object speed 223 stores object speed components in an X direction, a Y direction, and a Z direction that are calculated by the speed detection unit 103 based on information regarding the object positions in the current frame and the frame one frame preceding the current frame. Each microphone group ID 224 coincides with the microphone group ID 211 in the microphone group table 140. Each distance 225 is a distance between the object and one of the microphone groups.

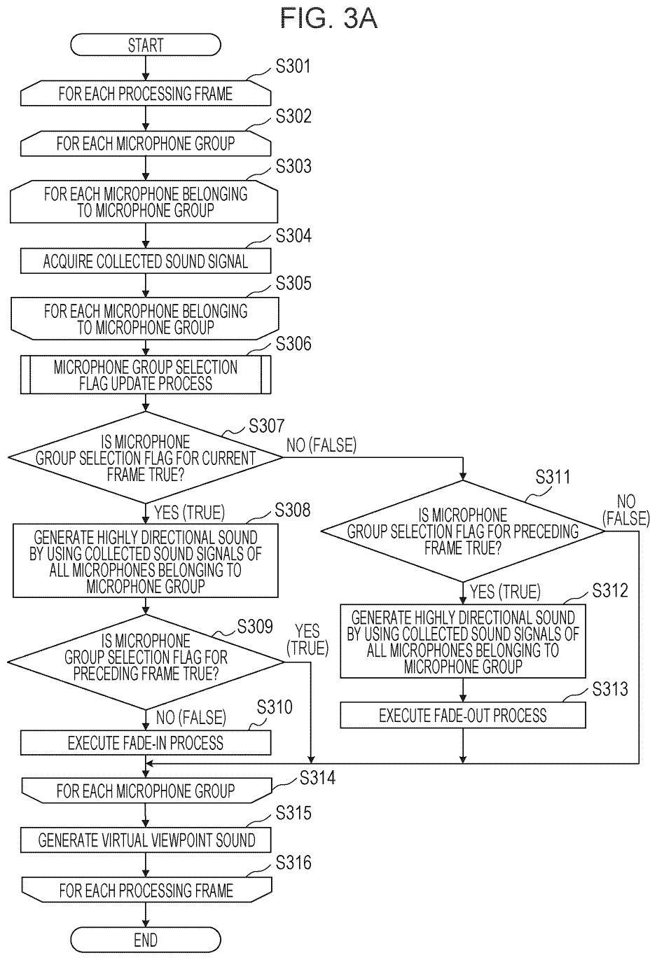

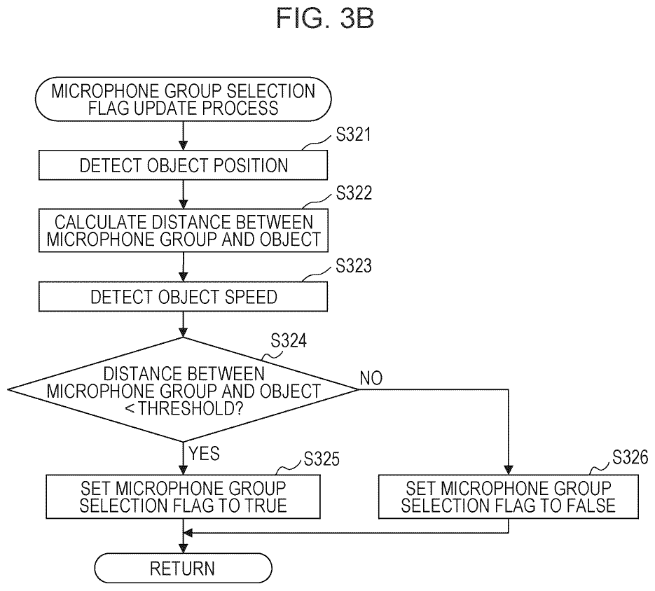

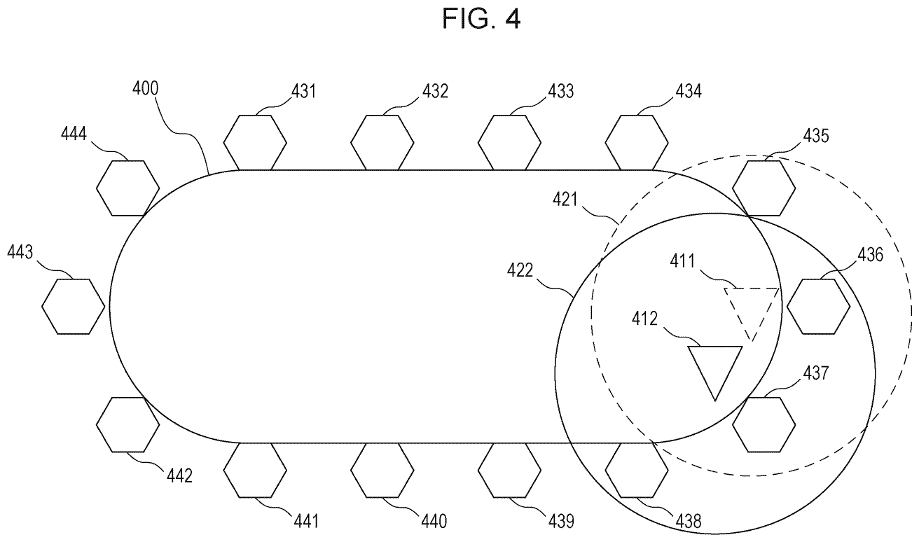

Operations of the information processing apparatus 100 with reference to FIG. 4 will then be described. FIGS. 3A and 3B are flowcharts illustrating example processing for the highly directional sound generation process executed by using the collected sound signals collected with the microphones to the generation of the virtual viewpoint sound. FIG. 4 is a view for explaining an example of arrangement of microphone groups and selection of processing target microphone groups.

In FIG. 3A, steps S301 to S316 are performed as loop processing performed for each processing frame. Steps S302 to S314 are performed as loop processing performed for each microphone group and are performed for all of the microphone groups. Steps S302 to S314 are thus repeated for all of the microphone groups registered in the microphone group table 140. FIG. 4 illustrates, as an example arrangement of the microphone groups, a state where microphone groups 431 to 444 are arranged along the outer circumference of a field 400. In the example in FIG. 4, steps S302 to S314 are performed for each of the microphone groups 431 to 444.

Steps S303 to S305 are performed on all of the microphones belonging to the microphone groups. In step S304, the collected sound signal acquisition unit 106 acquires collected sound signals for all of the microphones registered in the microphone master table 130 and stores the collected sound signals in the sound data storage unit 110. In these steps, the collected sound signals collected for all of the microphones belonging to the target microphone group in the loop processing composed of steps S302 to S314 are stored in the sound data storage unit 110. Any configuration in which collected sound signals are held in a storage area may be used, such as storing the collected sound signals in a file format.

In step S306, a process for updating the microphone group selection flags 213 in the microphone group table 140 is executed. FIG. 3B is a flowchart illustrating an example of the update process for microphone group selection flags that is executed in step S306.

In step S321 in FIG. 3B, based on image data or moving image data to be used to generate a virtual viewpoint image, the position detection unit 101 detects an object within a predetermined area (object) and the position thereof and updates the object position 222 in the object information table 150. For example, as illustrated in FIG. 4, the position of an object 412 is detected. In this embodiment, the position of the object is the position of the center of gravity of the area of the detected object but is not limited to this. For example, any position (for example, the position closest to the microphone group) in the area of the object may be used.

In step S322, the distance calculation unit 102 calculates a distance between the position of the object detected by the position detection unit 101 in step S321 and the target microphone group in the loop processing and updates the corresponding distance 225 in the object information table 150. The position of the microphone group is stored in the microphone position 212 in the microphone group table 140.

In step S323, the speed detection unit 103 detects the speed of the object by using the object position detected by the position detection unit 101 and updates the object speed 223, of the object, stored in the object information table 150. In this embodiment, the speed is calculated based on the respective positions of the object in the processing frame and the frame one frame preceding the processing frame but is not limited to this. For example, an average speed or an estimated speed may be calculated as the speed from the positions of the object in the plurality of frames in the past.

In step S324, the microphone group selection unit 104 determines whether the distance between the microphone group and the object position that is calculated in step S322 is less than a predetermined threshold. The microphone group selection unit 104 selects, as the processing target microphone group, a microphone group having the calculated distance less than the threshold. Accordingly, if the microphone group selection unit 104 determines that the calculated distance is less than the threshold (YES in S324), step S325 is performed. If the microphone group selection unit 104 determines that the calculated distance is not less than the threshold, that is, if the calculated distance is greater than or equal to the threshold (NO in S324), step S326 is performed.

In step S325, the microphone group selection unit 104 sets, to TRUE, the microphone group selection flag 213 for the current frame in the microphone group table 140.

In contrast, in step S326, the microphone group selection unit 104 sets, to FALSE, the microphone group selection flag 213 for the current frame in the microphone group table 140.

In steps S325 and S326, the microphone group selection unit 104 updates the microphone group selection flag 213 for the previous frame by storing the flag having stored as the microphone group selection flag 213 for the current frame.

A value is determined in advance as the threshold used for the determination in step S324 in this embodiment, but the threshold is not limited to this. For example, different values for the respective processing frames may be set based on the object speed calculated in step S323. The information processing apparatus 100 may also be separately provided with an object orientation detection unit (not illustrated) that detects the orientation of the object. Based on the orientation of the object serving as a reference, a threshold varying with an angle made to the reference may be set. FIG. 4 illustrates the object 412 in a processing frame N and a range 422 in which the object 412 is centered and located at a distance within the predetermined threshold. FIG. 4 is represented two-dimensionally for convenience, and thus the range 422 is represented by a circle. However, the range 422 actually has a three-dimensional structure, and thus a spherical surface forms a boundary. FIG. 4 likewise illustrates an object 411 in a processing frame (N−1) one frame preceding the processing frame N and a range 421 in which the object 411 is centered and located at a distance within the predetermined threshold. In the example in FIG. 4, in the processing frame N, the microphone groups 436, 437, and 438 are selected as processing target microphone groups to undergo the highly directional sound generation process. In the processing frame (N−1), the microphone groups 435, 436, and 437 are selected as the processing target microphone groups to undergo the highly directional sound generation process. Each microphone group is conveniently represented by using graphics in FIG. 4; however, in this embodiment, parameters used to calculate a distance between an object and a microphone group are the X coordinate, the Y coordinate, and the Z coordinate of the center of gravity of the object. For this reason, if the center points of the graphics of the microphone groups are included in the ranges 421 and 422 in FIG. 4, the microphone groups are determined as the processing target microphone groups for the highly directional sound generation process.

The details of the process for updating microphone group selection flags executed in step S306 have heretofore been described.

Referring back to FIG. 3A, in step S307, the microphone group selection unit 104 determines whether the microphone group selection flag for the current processing frame updated in step S306 is TRUE or FALSE. If the microphone group selection unit 104 determines that the microphone group selection flag for the current frame is TRUE (YES in S307), step S308 is performed. In contrast, if the microphone group selection unit 104 determines that the microphone group selection flag for the current frame is FALSE (NO in S307), step S311 is performed.

In step S308, the first sound generation unit 107 executes the highly directional sound generation process by using the collected sound signals of the microphones belonging to the processing target microphone group. The first sound generation unit 107 stores, in the sound data storage unit 110, highly directional sound data acquired as the execution result of the highly directional sound generation process. As in step S304, any configuration in which highly directional sound data is held in a storage area may be used, such as storing the highly directional sound data in a file format.

In step S309, the change detection unit 105 determines whether the microphone group selection flag for the previous frame held by the microphone group table 140 is TRUE or FALSE. If the change detection unit 105 determines that the microphone group selection flag for the previous frame is TRUE (YES in S309), step S310 is skipped, and step S314 is performed. If the change detection unit 105 determines that the microphone group selection flag for the previous frame is FALSE (NO in S309), step S310 is performed. That is, if the change detection unit 105 determines that the microphone group is not to be processed in the previous frame but becomes a processing target microphone group in the current frame, step S310 is performed. Information regarding the one frame that precedes the current frame is stored as information regarding a frame in the past. However, information regarding any number of frames in the past may be stored. It may then be determined whether a predetermined number of frames have elapsed since a previously selected microphone group was deselected in a past frame. Likewise, it may be determined whether a predetermined number of frames have elapsed since a previously unselected microphone group was selected in a past frame.

In step S310, the noise reducing unit 108 applies a fade-in process to the highly directional sound data generated in step S308. In the fade-in process, the sound strength is enhanced continuously over time. The fade-in process causes sound continuity to be maintained and thus leads to noise reduction. The fade-in process is executed to be completed within the current frame in this embodiment but is not limited to this. For example, the fade-in process may be set to be completed within any number of frames based on the object speed stored in the object information table 150.

In step S311, as in step S309, the change detection unit 105 determines whether the microphone group selection flag for the previous frame held by the microphone group table 140 is TRUE or FALSE. If the change detection unit 105 determines that the microphone group selection flag for the previous frame is TRUE (YES in S311), step S312 is performed. That is, if the change detection unit 105 determines that the microphone group is a processing target microphone group in the previous frame but becomes a microphone group which is not used in the current frame, step S312 is performed. If the change detection unit 105 determines that the microphone group selection flag for the previous frame is FALSE (NO in S311), steps S312 to S313 are skipped, and step S314 is performed.

In step S312, as in step S308, the first sound generation unit 107 executes the highly directional sound generation process by using the collected sound signals of the microphones belonging to the processing target microphone group. The first sound generation unit 107 stores, in the sound data storage unit 110, highly directional sound data acquired as the execution result of the highly directional sound generation process.

In step S313, the noise reducing unit 108 applies a fade-out process to the highly directional sound data generated in step S312. In the fade-out process, the sound strength is weakened continuously over time. The fade-out process causes sound continuity to be maintained and thus leads to noise reduction. As in step S310, the fade-out process is performed to be completed within the current frame in this embodiment but is not limited to this. For example, the fade-out process may be set to be completed within any number of frames based on the object speed stored in the object information table 150.

In step S315, the second sound generation unit 109 generates virtual viewpoint sound by using the sound data stored in the sound data storage unit 110. For example, the virtual viewpoint sound may be generated by synthesizing all of the collected sound signals stored in the sound data storage unit 110 and the highly directional sound data or synthesizing only the highly directional sound data without using the collected sound signals.

The noise reducing unit 108 applies the fade-in process or the fade-out process to the highly directional sound data generated in step S308 in this embodiment, but the configuration is not limited to this. For example, when generating the virtual viewpoint sound, the second sound generation unit 109 may apply the fade-in process or the fade-out process to the collected sound signals collected with the microphones included in the microphone groups, based on the microphone group selection flag in the microphone group table 140.

The highly directional sound generation process is executed on all of the microphone groups determined to be located at a distance less than the threshold from the position of the object in this embodiment, but the configuration is not limited to this. For example, the number of microphone groups serving as processing targets for the highly directional sound generation process may be limited. For example, a predetermined number of microphone groups may be selected in order from the shortest distance from the position of the object to serve as the target for the highly directional sound generation process. If any of the microphone groups is not less than the threshold, for example, a predetermined number of microphone groups may be selected in order from the shortest distance from the position of the object to serve as a target for the highly directional sound generation process.

The number of objects is 1 in the description for this embodiment but may be plural. If multiple objects are detected to serve as processing targets, steps S302 to S314 (steps S303 to S305 are common to all of the objects and thus do not have to be performed) are performed for each object, and thereby the virtual viewpoint sound can be generated based on highly directional sound data generated for each object.

In response to a change of the processing target microphone group between the processing frame and the frame one frame preceding the processing frame, the noise reduction process is executed on the sound data. Noise attributed to a discontinuous waveform occurring due to the use of highly directional sound data based on different processing target microphone groups may thereby be reduced. Noise of the virtual viewpoint sound generated as sound for reproduction may thus be reduced, and virtual viewpoint sound with auditory discomfort reduced may be achieved.

### Embodiment 2

As described above, for determination to select a microphone group to undergo the highly directional sound generation process, a distance between the object and each of the microphone groups in a processing frame and the frame one frame preceding the processing frame is used. In another embodiment, two thresholds that are a first threshold and a second threshold (the first threshold<the second threshold) are set for a processing frame. The distance between the microphone group and the object is compared with the thresholds, and thereby whether to select the microphone group as the microphone group to undergo the highly directional sound generation process is determined. That is, a microphone group serving as a target for two types of processing is selected in one processing frame, for a microphone group satisfying a predetermined condition for a positional relationship with the object. In this embodiment, two thresholds are set, but three or more thresholds may be set.

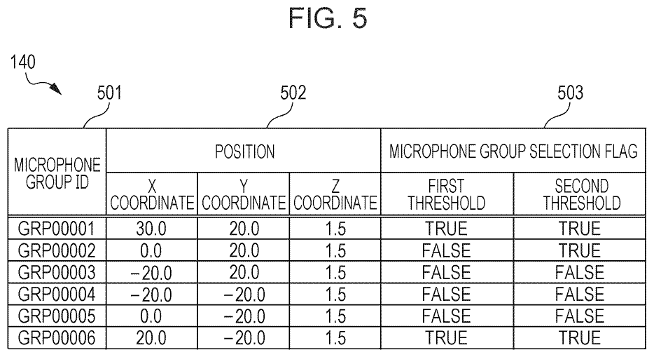

The functional configuration of the information processing apparatus 100 is the same as that of the information processing apparatus 100 illustrated in FIG. 1, and thus the description thereof is omitted. In this embodiment, microphone groups are managed by using the microphone group table 140 exemplified as in FIG. 5. FIG. 5 is a table illustrating an example of a microphone group table 140. As illustrated in FIG. 5, the microphone group table 140 stores microphone group IDs 501 for uniquely identifying microphone groups, microphone positions 502 of microphones belonging to the microphone groups, and microphone group selection flags 503. The microphone group IDs 501 and the microphone positions 502 are the same as the microphone group IDs 211 and the microphone positions 212 illustrated in FIG. 2B. The microphone group selection flags 503 are flags to distinguish whether a microphone group is selected as a processing target to undergo the highly directional sound generation process. The microphone group selection flags 503 store flags each for a corresponding one of the first threshold and the second threshold. The microphone master table 130 and the object information table 150 are the same as those described above.

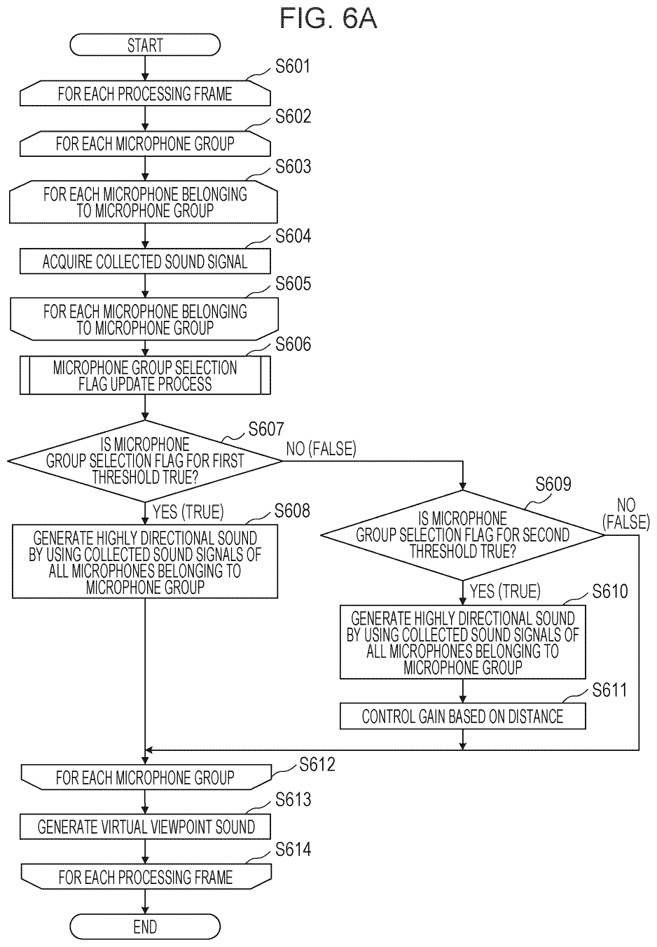

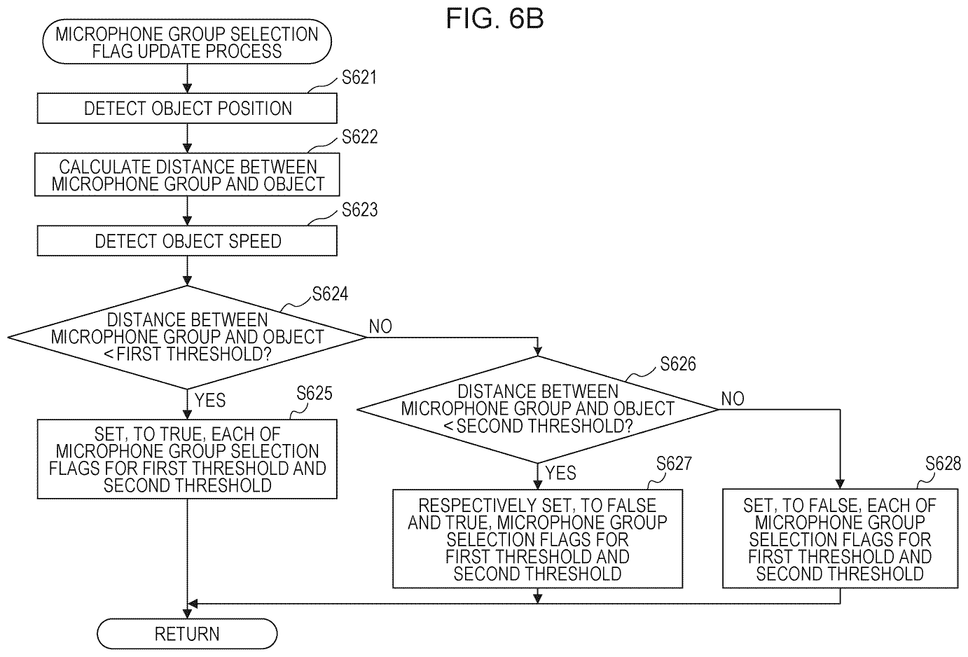

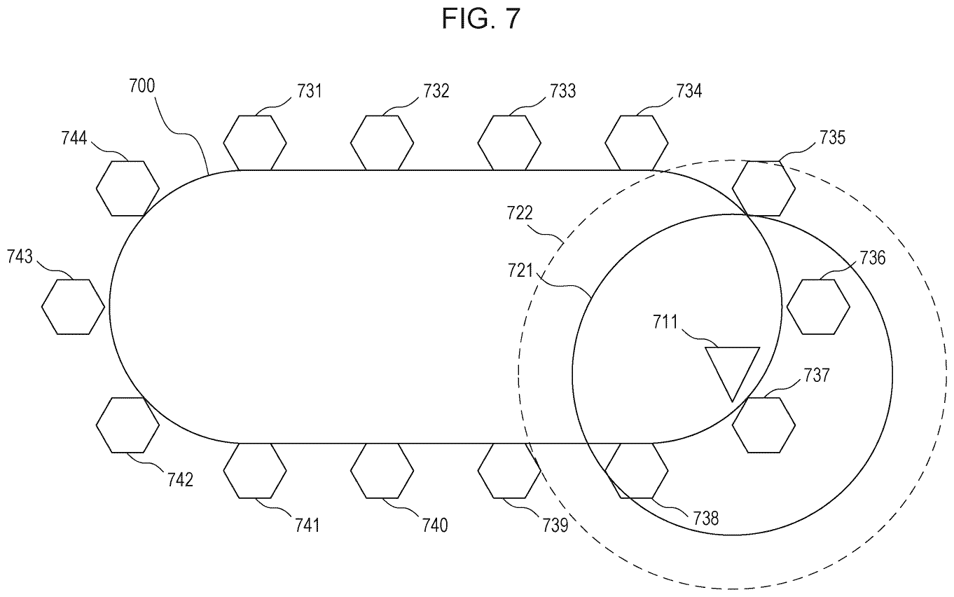

FIGS. 6A and 6B are flowcharts illustrating example processing for a highly directional sound generation process executed by using collected sound signals collected with microphones to the generation of the virtual viewpoint sound. FIG. 7 is a view for explaining an example of arrangement of microphone groups and selection of processing target microphone groups.

Steps S601 to S605, S608, S610, and S612 to S614 in FIG. 6A are the same as steps S301 to S305, S308, S312, and S314 to S316 in FIG. 3A. Steps S621 to S623 in FIG. 6B are the same as steps S321 to S323 in FIG. 3B. The description thereof is thus omitted.

In step S606, a process for updating microphone group selection flags for the first threshold and the second threshold in the microphone group table 140 is executed. FIG. 6B is a flowchart illustrating an example of the process for updating microphone group selection flags in this secondary embodiment executed in step S606.

In step S624 in FIG. 6B, the microphone group selection unit 104 determines whether the distance between the microphone group and the object position calculated in step S622 is less than the first threshold. The microphone group selection unit 104 selects, as a processing target microphone group, a microphone group having the calculated distance less than the first threshold. Accordingly, if the microphone group selection unit 104 determines that the calculated distance is less than the first threshold (YES in S624), step S625 is performed. If the microphone group selection unit 104 determines that the calculated distance is not less than the first threshold, that is, if the calculated distance is greater than or equal to the first threshold (NO in S624), step S626 is performed.

In step S625, the microphone group selection unit 104 sets, to TRUE, each of the flags for the first threshold and the second threshold in the microphone group selection flag 503 in the microphone group table 140.

In step S626, the microphone group selection unit 104 determines whether the distance between the microphone group and the object position calculated in step S622 is less than the second threshold.

The value of the second threshold is greater than the value of the first threshold. The microphone group selection unit 104 selects, as the processing target microphone group, a microphone group having the calculated distance less than the second threshold. Accordingly, if the microphone group selection unit 104 determines that the calculated distance is less than the second threshold, that is, if the calculated distance is greater than or equal to the first threshold and less than the second threshold (YES in S626), step S627 is performed. If the microphone group selection unit 104 determines that the calculated distance is not less than the second threshold, that is, if the calculated distance is greater than or equal to the second threshold (NO in S626), step S628 is performed.

In step S627, the microphone group selection unit 104 sets, to FALSE, the flag for the first threshold in the microphone group selection flag 503 in the microphone group table 140 and sets the flag for the second threshold to TRUE.

In step S628, the microphone group selection unit 104 sets, to FALSE, each of the flags for the first threshold and the second threshold in the microphone group selection flag 503 in the microphone group table 140.

In this embodiment, the thresholds used for the determination in steps S624 and S626 are decided in advance but are not limited to this. For example, different values for respective frames may be set based on the object speed calculated in step S623. FIG. 7 illustrates an object 711 in a processing frame, a range 721, and a range 722. In the ranges 721 and 722, the object 711 is centered and located at respective distances within the first threshold and the second threshold. In the example in FIG. 7, microphone groups 736, 737, and 738 are selected as the processing target microphone groups for the first threshold. As the processing target microphone group for the second threshold, a microphone group 735 is selected in addition to the microphone groups 736, 737, and 738 for the first threshold. Like the example in FIG. 4, if the center points of the graphics of the microphone groups are included in the ranges 721 and 722 in FIG. 7, it is determined that the microphone groups are selected as the processing target microphone groups.

The details of the process for updating microphone group selection flags executed in step S606 have heretofore been described.

Referring back to FIG. 6A, in step S607, the microphone group selection unit 104 determines whether the microphone group selection flag for the first threshold updated in step S606 is TRUE or FALSE. If the microphone group selection unit 104 determines that the microphone group selection flag for the first threshold is TRUE (YES in S607), step S608 is performed. In contrast, if the microphone group selection unit 104 determines that the microphone group selection flag for the first threshold is FALSE (NO in S607), step S609 is performed.

In step S609, the microphone group selection unit 104 determines whether the microphone group selection flag for the second threshold updated in step S606 is TRUE or FALSE. If the microphone group selection unit 104 determines that the microphone group selection flag for the second threshold is TRUE (YES in S609), step S610 is performed. In contrast, if the microphone group selection unit 104 determines that the microphone group selection flag for the second threshold is FALSE (NO in S609), steps S610 to S611 are skipped, and step S612 is performed.

In step S611, the noise reducing unit 108 applies a gain control process to the highly directional sound data generated in step S610. The gain control process is executed by multiplying a gain coefficient G by the amplitude of the highly directional sound. The gain coefficient G is calculated, for example, by using the following formula, where the value of the first threshold is T1, the value of the second threshold is T2, and a distance calculated in step S622 is D.

$$G = ( ( T 2 - D ) / ( T 2 - T 1 ) ) / 100$$

If a distance from the object coincides with the value of the first threshold, 100% is set. If the distance coincides with the value of the second threshold, 0% is set. The amplitude of a microphone group between these values is controlled in proportion to the distance.

The gain control process is executed as described above in this embodiment but is not limited to this. For example, the gain is controlled in proportion to the distance in the example described above, but a gain coefficient may be obtained by applying an exponential function.

Accordingly, noise may be reduced by setting the two thresholds for each processing frame and by executing the noise reduction process completed within the single processing frame, according to a difference between the processing target microphone groups selected based on the thresholds. Noise of the virtual viewpoint sound generated as the sound for reproduction may thus be reduced, and virtual viewpoint sound with reduced auditory discomfort may be achieved.

### Other Embodiments

The present disclosure may be implemented by processing in which one or more processors in a computer of a system or an apparatus read out and run a program implementing one or more functions of the embodiment described above, the program being provided to the system or the apparatus via a network or a storage medium. The present disclosure may also be implemented by a circuit (for example, an ASIC) implementing one or more functions.

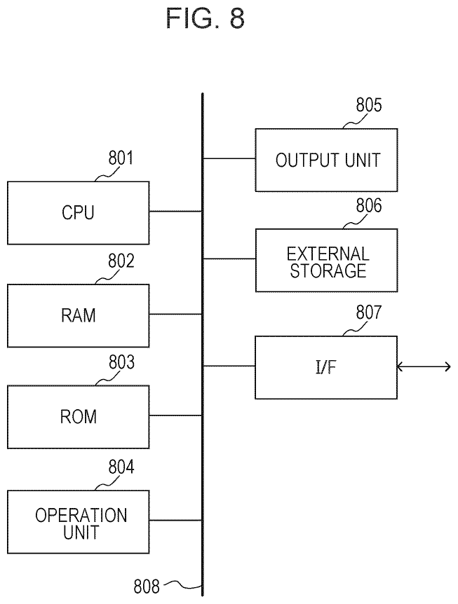

For example, the information processing apparatus 100 may be implemented by a computer as illustrated in FIG. 8, and operations are performed by a CPU 801 of the computer. FIG. 8 is a block diagram illustrating an example of a computer hardware configuration applicable to the information processing apparatus according to the embodiments.

The CPU 801 performs overall control of the computer by using computer programs and data stored in a RAM 802 and a ROM 803 and performs processing described above by the information processing apparatus according to the embodiments described above. The CPU 801 thus functions as the functional units illustrated in FIG. 1. The RAM 802 has an area for temporarily storing a computer program and data loaded from an external storage 806, data acquired from an external device via an interface (I/F) 807, and the like. Further, the RAM 802 has a work area used when the CPU 801 executes various processes. The RAM 802 is capable of storing various pieces of data such as microphone information and microphone parameters. In addition, sound data may be managed by the RAM 802. The ROM 803 stores settings data of the computer, a boot program, and the like.

An operation unit 804 is composed of, for example, a keyboard and a mouse. A user of the computer operates the operation unit 804, and thereby various instructions may be input to the CPU 801. An output unit 805 is composed of, for example, a liquid crystal display and displays a result of processing by the CPU 801. The operation unit 804 and the output unit 805 are not necessarily required, and input and output may be performed by using the I/F 807. The external storage 806 is a large-capacity information storage device represented by a hard disk drive device. The external storage 806 stores the operating system (OS), computer programs to cause the CPU 801 to implement the functions of the units illustrated in FIG. 1, and the like. Furthermore, the external storage 806 may store collected sound signals to be processed. The external storage 806 is also capable of storing sound data. The computer programs and the data stored in the external storage 806 are appropriately loaded into the RAM 802 under the control of the CPU 801 and to be processed by the CPU 801. To the I/F 807, a network such as a LAN or the Internet and other devices such as a projector and a display may be connected. The computer is capable of acquiring and transmitting various pieces of information via the I/F 807. Reference 808 denotes a bus communicatively connecting the functional units described above.

The embodiments described above are each provided as merely an example in implementing the present disclosure, and the technical scope of the present disclosure should not be construed from the embodiments in a limiting manner. The present disclosure may be implemented in various forms without departing from the technical spirit and main features thereof.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-206480 filed Nov. 27, 2024, which is hereby incorporated by reference herein in its entirety.

What is claimed is:

1. An information processing apparatus comprising:
one or more memories storing instructions; and
one or more processors executing the instructions to:
detect a position of an object in a predetermined area;
select a processing target microphone group that satisfies a predetermined condition for a positional relationship with the object, the processing target microphone group being included in a plurality of microphone groups for collecting sound in the predetermined area;
in response to a change of the selected processing target microphone group, execute a noise reduction process on sound data;
generate, by the processing target microphone group including processing target microphone groups, highly directional sound data for each processing target microphone group from collected sound signals acquired from a plurality of microphones; and
based on a plurality of pieces of sound data including the generated highly directional sound data, generate sound for reproduction.

2. The information processing apparatus according to claim 1,
wherein the one or more processors execute the instructions to
further detect a change of the selected processing target microphone group, and
in response to the change of the processing target microphone group detected by a change detection unit, execute the noise reduction process.

3. The information processing apparatus according to claim 1,
wherein the one or more processors execute the instructions to select, as the processing target microphone group, a microphone group included in the microphone groups that is located at a distance less than a threshold, the distance being between the object and the microphone group.

4. The information processing apparatus according to claim 3,
wherein the one or more processors execute the instructions to
if the processing target microphone group becomes a microphone group not to be processed, execute a fade-out process on sound data of the microphone group not to be processed, and
if a processing target microphone group not to be processed becomes a processing target microphone group, execute a fade-in process on sound data of the processing target microphone group.

5. The information processing apparatus according to claim 3,
wherein the one or more processors execute the instructions to detect speed of the object, and
wherein the threshold is set based on the detected speed of the object.

6. The information processing apparatus according to claim 1,
wherein the one or more processors execute the instructions to select, as the processing target microphone group, a microphone group included in the microphone groups that is located at a distance less than a second threshold greater than a first threshold, the distance being between the object and the microphone group, and
perform a gain control on sound data of the microphone group located at a distance from the object, the distance being greater than or equal to the first threshold and less than the second threshold.

7. The information processing apparatus according to claim 6,
wherein the one or more processors execute the instructions to perform the gain control by using a gain coefficient determined based on the distance from the object.

8. The information processing apparatus according to claim 6,
wherein the one or more processors execute the instructions to detect speed of the object, and
wherein the first threshold and the second threshold are set based on the detected speed of the object.

9. The information processing apparatus according to claim 1,
wherein the one or more processors execute the instructions to detect speed of the object, and
execute the noise reduction process that varies depending on the detected speed of the object.

10. The information processing apparatus according to claim 1,
wherein the one or more processors execute the instructions to execute the noise reduction process that varies depending on a plurality of selected processing target microphone groups that are included in the selected processing target microphone group.

11. A method for controlling an information processing apparatus, comprising:
detecting a position of an object in a predetermined area;
selecting a processing target microphone group that satisfies a predetermined condition for a positional relationship with the object, the processing target microphone group being included in a plurality of microphone groups for collecting sound in the predetermined area;
in response to a change of the selected processing target microphone group, executing a noise reduction process on sound data;
generating, by the processing target microphone group including processing target microphone groups, highly directional sound data for each processing target microphone group from collected sound signals acquired from a plurality of microphones; and
based on a plurality of pieces of sound data including the generated highly directional sound data, generating sound for reproduction.

12. A non-transitory computer readable storage medium storing a program which causes a computer to perform an information processing method, the information processing method comprising:
detecting a position of an object in a predetermined area;
selecting a processing target microphone group that satisfies a predetermined condition for a positional relationship with the object, the processing target microphone group being included in a plurality of microphone groups for collecting sound in the predetermined area;
in response to a change of the selected processing target microphone group, executing a noise reduction process on sound data;
generating, by the processing target microphone group including processing target microphone groups, highly directional sound data for each processing target microphone group from collected sound signals acquired from a plurality of microphones; and
based on a plurality of pieces of sound data including the generated highly directional sound data, generating sound for reproduction.
